(19) United States
(12) Patent Application Publication
(10) Pub. No.: US 2019/0286327 A1
(43) Pub. Date: Sep. 19, 2019

(54) Memory Objects

(71) Applicant: Apple Inc., Cupertino, CA (US)

(72) Inventors: Alan E. Falloon, Ashton (CA); Dino R. Canton, Nepean (CA); Sunil Kittur, Kanata (CA)

(21) Appl. No.: 16/266,296

(22) Filed: Feb. 4, 2019

Related U.S. Application Data
(60) Provisional application No. 62/643,245, filed on Mar. 15, 2018.

(51) Int. Cl. G06F 3/06; G06F 12/0802

(52) U.S. Cl. CPC G06F 3/0604; G06F 3/0644; G06F 2212/7201; G06F 12/0802; G06F 3/0673

(57) ABSTRACT

In an embodiment, a memory manager for a privileged program in an electronic system may manage multiple memory pools having different attributes. The memory manager may provide memory objects drawn from a memory pool or memory pool slice to various memory requestors (e.g. user space threads/programs, etc.). By ensuring that the memory pool slices/memory objects are isolated from each other (e.g. non-overlapping memory ranges, for example), the memory manager may ensure the protection of address spaces of different programs. Additionally, various attributes and permissions for the memory pool slices/memory objects may be controlled by the memory manager.

This application claims benefit of priority to U.S. Provisional Patent Application Ser. No. 62/643,245, filed on Mar. 15, 2018. The above application is incorporated herein by reference in its entirety. To the extent that anything in the above application contradicts the material expressly set forth herein, the material expressly set forth herein controls.

### BACKGROUND

### Technical Field

This disclosure relates generally to electronic systems and, more particularly, to memory allocation to programs executing on electronic systems.

### Description of the Related Art

Most electronic systems (e.g. computing systems, whether stand alone or embedded in other devices) execute various programs to provide functionality for the user of the system. For example, client programs may execute on an electronic system, providing a user interface and/or other functionality on the electronic system. The client program may communicate with a server program executing on the electronic system or on a different electronic system to utilize one or more services provided by the server. For example, file servers may provide file storage, read and write of the files, etc. Application servers may provide application execution for the client, so that the client need not execute the application directly. A print server may manage one or more printers on a network and provide printing services. Communications servers may provide communication operations for a network such as email, firewall, remote access, etc. Database servers provide database management and access. There are many other types of servers.

Each program executed on the electronic system generally requires access to memory in a memory address space supported by the system. The processors in the electronic system fetch program instructions from the memory address space and access data in the memory address space as well. Multiple programs (or threads within programs) can be in concurrent execution on the electronic system. For example, threads/programs can be executing simultaneously on multiple processors in the system. Additionally or in the alternative, multiple threads can be in concurrent execution on a processor via context switching between the threads under the control of an operating system or other supervisory program and/or multi-threaded support on the processor.

Programs are typically allocated memory that is isolated from other programs (or that is shared in a known and controlled way, such as through semaphores and the like) to ensure correct execution of programs and to protect programs against incorrect execution of other programs, among other things. Virtual memory systems are frequently employed in which the addresses generated during program execution are virtual address mapped to physical addresses of physical memory locations via an address translation system. Thus, mechanisms to manage which physical addresses are accessible to which programs are a critical part of modern operating systems.

### SUMMARY

In an embodiment, a memory manager for a privileged program in an electronic system may manage multiple memory pools having different attributes. The memory manager may provide memory objects (or slices of memory objects) drawn from a memory pool or memory pool slice to various memory requestors (e.g. user space threads/programs, etc.). By ensuring that the memory pool slices/memory objects are isolated from each other (e.g. non-overlapping memory ranges, for example), the memory manager may ensure the protection of address spaces of different programs. Additionally, various attributes and permissions for the memory pool slices/memory objects may be controlled by the memory manager. A memory pool slice or memory object/slice may have more restrictive permissions than those of its parent memory pool or memory pool slice. Memory pool slices may also have more restrictive attributes, in an embodiment.

### BRIEF DESCRIPTION OF THE DRAWINGS

The following detailed description makes reference to the accompanying drawings, which are now briefly described.

FIG. 1 is a block diagram of one embodiment of an operating system in accordance with this disclosure.

FIG. 2 is a block diagram of one embodiment of memory pools and memory objects in accordance with this disclosure.

FIG. 3 is a pair of tables illustrating attributes for one embodiment of the memory pools/objects and another table illustrating access permissions for one embodiment of the memory pools/objects.

FIG. 4 is a flowchart illustrating operation of one embodiment of portions of the system shown in FIG. 1 during boot of the system.

FIG. 5 is a flowchart illustrating operation of one embodiment of the kernel shown in FIG. 1 to initialize a process for execution.

FIG. 6 is a flowchart illustrating operation of one embodiment of a user space thread shown in FIG. 1, including certain memory object manipulations that may occur during execution.

FIG. 7 is a flowchart illustrating operation of one embodiment of the kernel memory manager shown in FIG. 1 in response to a Cid request from a thread.

FIG. 8 is a flowchart illustrating operation of one embodiment of the kernel memory manager shown in FIG. 1 in response to a slice request from a thread.

FIG. 9 is a flowchart illustrating operation of one embodiment of the kernel memory manager shown in FIG. 1 in response to a memory map request from a thread.

FIG. 10 is a flowchart illustrating operation of one embodiment of the kernel memory manager shown in FIG. 1 in response to a memory unmap request from a thread.

FIG. 11 is a flowchart illustrating operation of one embodiment of the kernel memory manager shown in FIG. 1 in response to an object release request from a thread.

FIG. 12 is a block diagram of one embodiment of a computer system.

FIG. 13 is a block diagram of one embodiment of a computer accessible storage medium.

While this disclosure may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used herein, the terms “first,” “second,” etc. are used as labels for nouns that they precede, and do not imply any type of ordering (e.g., spatial, temporal, logical, etc.) unless specifically stated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible. In general, the circuitry that forms the structure corresponding to “configured to” may include hardware circuits. The hardware circuits may include any combination of combinatorial logic circuitry, clocked storage devices such as flip-flops, registers, latches, etc., finite state machines, memory such as static random access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims a unit/circuit/component or other structure that is configured to perform one or more tasks is expressly intended not to invoke 35 U.S.C. § 112(f) interpretation for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

As used herein, the term “based on” or “dependent on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure. Generally, this disclosure is not intended to refer to one particular implementation, but rather a range of embodiments that fall within the spirit of the present disclosure, including the appended claims.

### DETAILED DESCRIPTION OF EMBODIMENTS

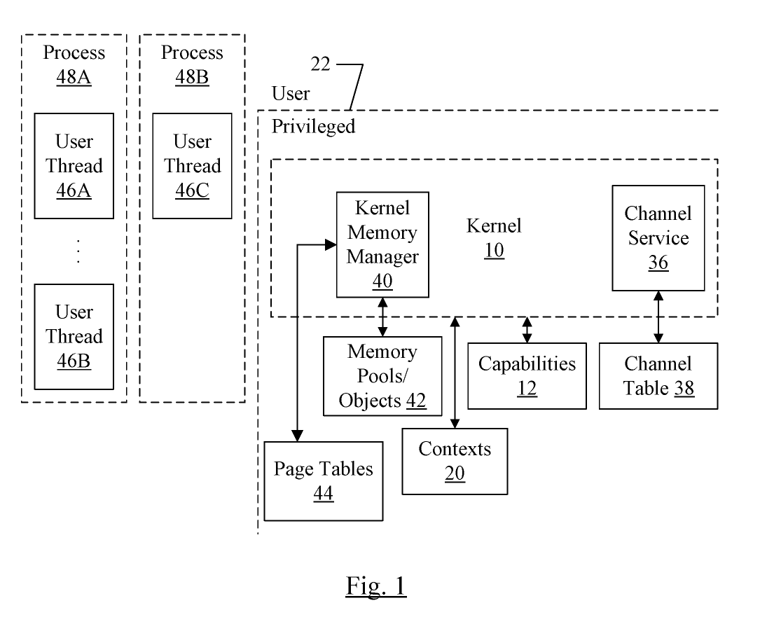

Turning now to FIG. 1, a block diagram of one embodiment of an operating system and related data structures is shown. In the illustrated embodiment, the operating system includes a kernel 10, a set of capabilities 12, a set of contexts 20, memory pools/objects 42, one or more page tables or other translation data structures 44. The kernel 10 may maintain the one or more contexts 20, which may include contexts for the user threads 46A-46C and/or the user processes 48A-48B. The kernel 10, in the embodiment of FIG. 1, may include a channel service 36 which may maintain a channel table 38. The kernel 10 may further include a kernel memory manager 40 that may maintain the memory pools/objects 42 and the page tables 44.

A thread may be the smallest granule of instruction code that may be scheduled for execution in the system. Generally, a process includes at least one thread, and may include multiple threads. A process may be an instance of a running program. The discussion herein may refer to threads for simplicity, but may equally apply to a single threaded or multi-threaded process or program. Similarly, the discussion may refer to processes, but may equally apply to a thread in a multi-threaded process.

The kernel memory manager 40 may be configured to allocate physical memory based on the memory pools provided to the kernel memory manager 40. For example, during boot, the kernel 10 may determine the physical address map for the system, including portions of the memory that are memory mapped input/output (I/O) addresses for various devices in the system (e.g. peripheral devices, not shown in FIG. 1) and portions that are mapped to physical memory locations (e.g. locations within a random access memory (RAM) such as static RAM (SRAM), dynamic RAM (DRAM) including double data rate (DDR) DRAM compatible with various industry standards, various types of non-volatile memory, etc.). Viewed in another way, physical memory addresses may not be subject to remapping, unlike virtual addresses which can be remapped to a physical address identifying a specific physical memory storage location (e.g. via the page tables 44).

The kernel memory manager 40 may receive various requests for physical memory and may respond with a memory object or a memory object slice. The memory object is derived from a memory pool (or memory pool slice) having attributes and permissions that are compatible with the request. In some cases, the memory object may include physical memory which is not allocated to another thread (and thus may be private to the process/thread). In other cases, the memory object may include physical memory which is also allocated to another thread, permitting shared memory. Alternatively, a memory object slice may be created from a memory object to share all or a portion of the physical memory. The separation of physical addresses between various memory objects/memory object slices may ensure that the independent threads/processes/programs may not interfere with each other's memory (e.g. by accessing (and particularly updating) memory being used by another thread/process/program). If memory objects/object slices are allocated with overlapping physical memory ranges, then the threads/processes/programs using the overlapping objects/object slices may do so in a controlled manner that is expected by the sharing threads/processes/programs.

Additionally, the memory pools and memory objects (and slices thereof) may have certain attributes and/or permissions that control the access to the memory. For example, memory may be allocated with read and write permission but not execute permission. Such memory may be used for data accessed by a given thread/process/program. For example, memory storing code (executable instruction sequences) may be allocated as read and execute but not writeable, so that the code may be executed but not modified. Any combination of read, write, and/or execute permissions may be supported, in an embodiment. That is, permissions may be none (no access), read-only, write-only, execute-only, read-write, read-execute, write-execute, or read-write-execute. Attributes may specify cacheability aspects of the memory, for example, or ordering models for device memory. The permissions for a given memory object may be the maximum permissions that may be used. A given mapping of virtual addresses to the physical addresses specified by the memory object may remove one or more permissions if desired. The attributes may be defined by the memory pool/memory pool slice from which a memory object is derived. In an embodiment, the attributes may not be modified in a memory object/memory object slice. Instead, the attributes may be inherited from the parent memory pool/pool slice/memory object.

Once one or more physical memory ranges are allocated from a pool/pool slice to a memory object, the memory object may own the physical memory range(s) until the object is destroyed. A memory object slice may be similar to a memory object, except that the memory object slice may be derived from a memory object and may provide access to a subset (or all) of the physical memory owned by the parent memory object. Permissions may be more restricted in the memory object slice than in the parent memory object, if desired. The attributes may not be modified (i.e. the attributes of the memory object slice may be the same as the parent memory object and thus may be the same as the memory pool/memory pool slice from which the memory object was allocated.

Memory object slices may be used for a variety of purposes. For example, the memory object slice may restrict permissions compared to the parent memory object. Thus, a given thread may provide another thread or process with access, but may enforce more restricted permissions (e.g. read-only). Also, the memory object slice may provide access to only a portion of the parent memory object's physical memory range. For example, a file system may have an executable file as a memory object with read-write-execute permission. The code portion of the memory object may be allocated to a memory slice that includes only read-execute permission or execute-only permission.

In some embodiments, the kernel memory manager 40 may allocate overlapping memory objects. For example, the memory storing code above may also be allocated to a loader thread that loads code into memory for execution. The loader thread may have read/write access to the memory object. Alternatively, the loader thread may first be allocated the memory object, and then may be deallocated the memory object after loading the code. The memory object may then be allocated (read and execute, or just execute) to the thread that executes the code. The shared memory example mentioned above is another case in which overlapping ranges may be allocated.

In an embodiment, each memory pool/object/slice may be accessed via a channel, as described in more detail below. The kernel memory manager 40 may allocate the pool/object/slice to a thread by providing the channel identifier (Cid) for the channel to the thread. To deallocate the memory pool/object/slice from a thread, the kernel memory manager 40 may delete the channel (and allocate another channel to the object), in an embodiment. The thread may return the Cid to the kernel memory manager 40 when the thread no longer requires the memory object, in some embodiments.

In an embodiment, access to hardware devices in a system (e.g. various peripheral devices, peripheral interface controllers, etc.) may be through memory mapped I/O. Thus, one or more memory pools may include memory that is mapped to the devices. Such pools (and slices or objects derived from such pools) may have attributes controlling how accesses to the devices are managed. Threads/processes/programs that are permitted to access a given device may be provided with a memory object that describes the memory range for the given device.

In an embodiment, any thread may request memory allocation from the kernel memory manager 40. Additionally, a thread 46A-46C may request that one or more virtual address ranges used by the thread be mapped to the physical memory owned by one or more memory objects allocated to the thread 46A-46C. The kernel memory manager 40 may include a virtual memory manager that maps virtual addresses (e.g. addresses generated by user threads 46A-46C) to physical addresses in the memory object(s) 42 through the page tables 44. Any translation policy may be used. The granule of memory allocation may be a page, which may be any desired size (e.g. 4 kilobytes (kB), 8 kB, 1 Megabyte (MB), 2 MB, 4 MB, etc.). There may be multiple pages in a memory pool, memory pool slice, memory object, or memory object slice. In some embodiments, there may be many pages in a memory pool, memory pool slice, memory object, or memory object slice.

In the illustrated embodiment, the kernel 10 may be part of a capability-based operating system. Other embodiments may not be capability-based. In the embodiment of FIG. 1, each capability 12 includes a function in an address space that is assigned to the capability 12. The data structure for the capability 12 may include, e.g., a pointer to the function in memory in a computer system. In an embodiment, a given capability 12 may include more than one function. In an embodiment, the capability 12 may also include a message mask defining which messages are permissible to send to the capability 12. In other embodiments, any other value(s) may be used to identify valid messages. A given thread/process which employs the capability 12 may further restrict the permissible messages, but may not override the messages which are not permissible in the capability 12 definition. That is, the capability 12 definition may define the maximum set of permissible messages, from which a given thread/process may remove additional messages.

Various threads may employ one or more capabilities 12 and/or may include code separate from the capabilities. A given thread may employ any number of capabilities, and a given capability may be employed by any number of threads.

The channel service 36 may be responsible for creating and maintaining channels between threads and various other objects. Channels may be the communication mechanism between threads for control messages. Data related to the control may be passed between threads/processes in any desired fashion. For example, shared memory areas, ring buffers, etc. may be used.

In an embodiment, a thread may create a channel on which other threads may send the thread messages. The channel service 36 may create the channel, and may provide an identifier (a channel identifier, or Cid) to the requesting thread. The Cid may be unique among the Cids assigned by the channel service 36, and thus may identify the corresponding channel unambiguously. The thread may provide the Cid (or “vend” the Cid) to another thread or threads, permitting those threads to communicate with the thread. In an embodiment, the thread may also assign a token (or “cookie”) to the channel, which may be used by the thread to verify that the message comes from a permitted thread. That is, the token may verify that the message is being received from a thread to which the channel-owning thread gave the Cid (or another thread to which the permitted thread passed the Cid). In an embodiment, the token may be inaccessible to the threads to which the Cid is passed, and thus may be unforgeable. For example, the token may be maintained by the channel service 36 and may be inserted into the message when a thread transmits the message on a channel. Alternatively, the token may be encrypted or otherwise hidden from the thread that uses the channel. In an embodiment, the token may be a pointer to a function in the channel-owning thread (e.g. a capability function or a function implemented by the channel-owning thread).

The channel service 36 may track various channels that have been created in the channel table 38. The channel table 38 may have any format that permits the channel service 36 to identify Cids and the threads to which they belong. When a message having a given Cid is received from a thread, the channel service 36 may identify the targeted thread via the Cid and may pass the message to the targeted thread.

Similarly, the kernel memory manager 40 may use the channels to provide access to memory objects, as previously mentioned. The kernel memory manager 40 may request the channels from the channel service 36, and may use the Cids returned by the channel service 36 to link threads to the memory objects.

The dotted line 22 divides the portion of the operating system that operates in user mode (or space) and the portion that operates in privileged mode/space. As can be seen in FIG. 1, the kernel 10 is the only portion of the operating system that executes in the privileged mode in this embodiment. Privileged mode may refer to a processor mode (in the processor executing the corresponding code) in which access to protected resources is permissible (e.g. control registers of the processor that control various processor features, certain instructions which access the protected resources may be executed without causing an exception, etc.). In the user mode, the processor restricts access to the protected resources and attempts by the code being executed to change the protected resources may result in an exception. Read access to the protected resources may not be permitted as well, in some cases, and attempts by the code to read such resources may similarly result in an exception.

The contexts 20 may be the data which the processor uses to resume executing a given code sequence. It may include settings for certain privileged registers, a copy of the user registers, etc., depending on the instruction set architecture implemented by the processor. Thus, each thread/process may have a context (or may have one created for it by the kernel 10).

The operating system may be used in any type of computing system, such as mobile systems (laptops, smart phones, tablets, etc.), desktop or server systems, and/or embedded systems. For example, the operating system may be in a computing system that is embedded in the product. In one particular case, the product may be a motor vehicle and the embedded computing system may provide one or more automated driving features. In some embodiments, the automated driving features may automate any portion of driving, up to and including fully automated driving in at least one embodiment, in which the human driver is eliminated.

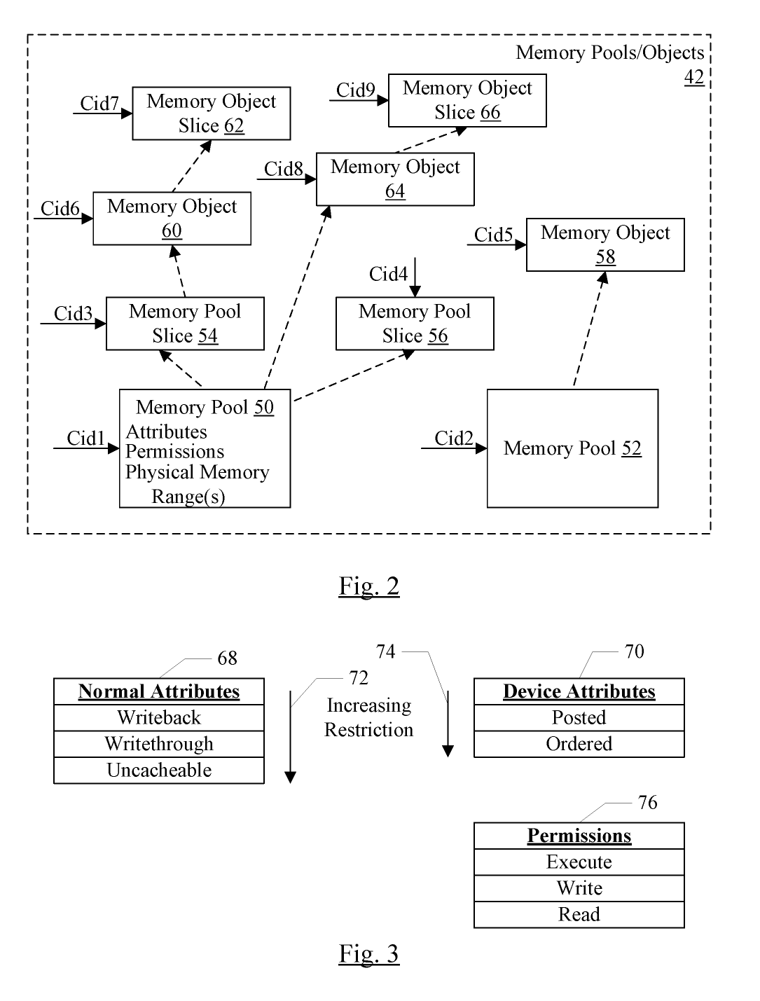

FIG. 2 is a block diagram illustrating one embodiment of the memory pools/objects 42. At the base of the memory pools/objects 42 are initial memory pools 50 and 52. At least two initial memory pools may be created: a “normal” memory pool and a “device” memory pool. The normal memory pool may describe random access memory (RAM) of any type, and the device memory pool may describe the memory address region(s) allocated to devices. There may be more than one of either type of memory pool. For example, there may be different normal memory pools if the normal memory has different performance characteristics (e.g. there are different memory devices that make up the total memory, having different latencies or bandwidths, for example). As another example, different memory pools may be provided with different permissions and/or attributes. Alternatively or in addition, the kernel memory manager 40 may define various memory pool slices (e.g. slices 54 and 56 in FIG. 2) with different permissions and/or attributes. The initial normal memory pool may have the most permissive permissions and attributes, in such an embodiment. In an embodiment, multiple device memory pools may be created with different permissions/attributes as well, or the initial device memory pool may have the most permissive permissions and attributes and device memory slices may be created with different permissions/attributes as needed by the devices that are addressed through each memory region.

The memory pool 50 is shown in expanded view in FIG. 2. Other memory pools, pool slices, memory objects, and memory object slices may be similar. The memory pool 50 includes an attributes field that defines the attributes of the memory described by the memory pool 50. The attributes may define the memory as device or normal memory. Alternatively, a separate field in the memory pool 50 may define device or normal memory. Other attributes may be characteristics of the memory that may be changed without impacting operation of the memory itself (e.g. cacheability). Other attributes may be characteristics of the memory or device that may be required for correct operation (e.g. write ordering properties). Permissions may define the types of accesses that are permitted to the memory. For example, read, write, and execute permissions may be defined. Additionally, the memory pool 50 includes one or more physical memory ranges (described by physical addresses). Each range may have a base address and bound, a base address and an end address, a base address and size, etc. Any mechanism for describing a range may be used.

As mentioned previously, the kernel memory manager 40 may define various memory pool slices from one of the base memory pools (or from another memory pool slice, in an embodiment). Memory objects may be defined from memory pools or memory pool slices, and memory object slices may be defined from memory objects. Relationships between memory pools, memory pool slices, memory objects, and memory object slices are illustrated via dotted arrows in the example of FIG. 2. Thus, memory pool slices 54 and 56 and the memory object 64 are derived from the memory pool 50, and the memory object 58 is derived from the memory pool 52. The memory object 60 is derived from the memory pool slice 54. The memory object slices 62 and 66 are derived from the memory objects 60 and 64, respectively. Each memory pool slice, memory object, or memory object slice may include a subset of the physical memory range(s) described by the parent pool, pool slice, or memory object. The subset may be any portion of the physical memory range(s), excluding at least a portion of the parent memory range. In an embodiment, the entirety of the parent's physical memory range(s) may be included in the memory pool slice, memory object, or memory object slice (e.g. to permit changing the permissions and/or, in the case of a pool slice, attributes).

Additionally, each memory pool slice, memory object, or memory object slice affords an opportunity to modify the permissions of the parent memory pool, memory pool slice, or memory object. The type attribute (normal or device) may not be modified, in an embodiment. Other attributes may be modified in a memory pool slice, but not in memory objects or memory object slices, in an embodiment. The attributes (in the case of a pool slice) and/or the permissions may be made more restrictive than the parent's attributes and/or permissions, but not less restrictive. Generally, an attribute may be more restrictive if the attribute would be lower performance (e.g. add latency, force less caching, etc.) or provide less functionality than another attribute. A permission may be more restrictive if it provides less access (e.g. fewer of the read, write or execute permissions are provided and any permissions that were not permitted in the parent are still not permitted in the child).

FIG. 3 shows a pair of tables 68 and 70 illustrating exemplary attributes for one embodiment for normal memory and device memory respectively. The order of entries in the table are from least restrictive to most restrictive, as indicated by arrows 72 and 74.

For normal memory (table 68), a cacheability attribute is supported in this embodiment. The least restrictive cacheability is writeback, in which writes to a cached block are captured in the cache and not propagated further unless a subsequent coherence event (e.g. a snoop or probe) causes the block to be flushed to memory or the next level in a cache hierarchy, the cache block is replaced in the cache, or the cache block is expressly flushed from the cache via instructions executed in the processor. The next least restrictive is writethrough, in which writes to a cached block are captured in the cache and are also propagated through the cache hierarchy to the lowest memory level (i.e. system memory). The most restrictive attribute is uncacheable, in which caching is not permitted.

For device memory (table 70), a write attribute is supported in which writes may be posted or ordered. Posted writes are less restrictive that ordered writes. Posted writes may be transmitted by the source, and there may be no response provided to the write. The source may consider the write complete when it has been successfully transmitted. Ordered writes provide an explicit response when complete, and a second write to the same device may not be transmitted until the response is received.

Also illustrated in FIG. 3 is a permissions table 76. The execute permission indicates that a processor may fetch instructions from the memory and execute them. The write permission indicates that the processor may write data to the memory. The read permission indicates that the processor may read data from the page. The execute, read, and write permissions may be orthogonal to each other. Thus, more restrictive permissions (when viewed in comparison to less restrictive permissions) may include fewer of the read, write, and execute permissions than the less restrictive permissions, and any of the read, write, and execute permissions that are not permitted in the less restrictive permissions are also not permitted in the more restrictive permissions. Viewed in another way, more restrictive permissions may be created from less restrictive permissions by disabling one or more of the enabled permissions in the less restrictive permissions, without enabling any disabled permissions.

Returning back to FIG. 2, each memory pool, memory pool slice, memory object, and memory object slice has a Cid assigned to it (Cid1 to Cid9 in FIG. 2). The kernel memory manager 40 may thus determine which other threads have access to a given memory pool, memory pool slice, memory object, or memory object slice by either providing the corresponding Cid (which the receiving thread may vend to other threads if desired) or not providing the corresponding Cid to a thread. For example, an embodiment of the kernel memory manager 40 may not provide Cid1 or Cid2 to any threads, thus retaining control of the base memory pools 50 and 52. The kernel memory manager 40 may also retain Cid3 and Cid4 to maintain control of memory pool slices 54 and 56. Alternatively, the kernel memory manager 40 may provide one or more of Cid3 or Cid4 to a thread that is trusted or authenticated in some fashion.

As mentioned previously, a slice may be defined from a memory pool or a memory object. Slices may be provided so that a portion of a memory pool or memory object may be further restricted, perhaps prior to providing the slice to a thread for which the further limitation is desired, even though the overall pool or object is less limited.

It is noted that, in addition to the attributes, permissions, and physical memory ranges, a memory object may also include various methods for providing access to the physical memory, ensuring that the physical memory retains its attributes and permissions, etc. The methods may be included in the capabilities functions 12, for example.

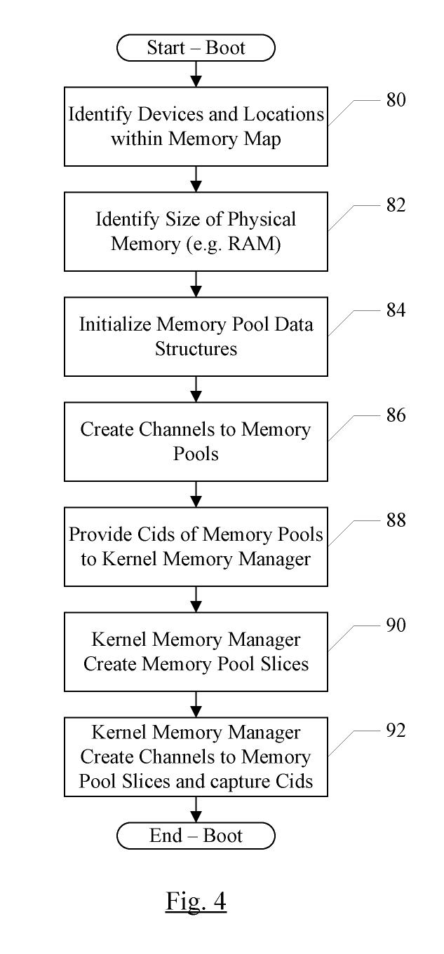

FIG. 4 is a flowchart illustrating a portion of the operation of one embodiment of the system shown in FIG. 1 during boot. The boot process may generally include initializing the system for operation. Some of the boot operation may be performed by other code prior to starting the operating system (e.g. low level boot code, possibly read from a read only memory (ROM)). While the blocks are shown in a particular order for ease of operation, other orders may be used. Blocks may be performed over multiple clock cycles. Various code sequences may include instructions which, when executed on a computing system, implement the operation shown in FIG. 4.

The kernel 10 may identify the devices in the system and their locations in the memory map (block 80). Additionally, the kernel 10 may identify the size of physical memory and its address range (e.g. taking into account the location of devices in the memory map—block 82). Alternatively, low level boot code may perform the operations of blocks 80 and 82 prior to the start of the kernel 10. The configuration of the system may be static, and the devices and/or memory size may be provided from a file. Alternatively, a discovery process may be used to determine one or both of the locations of devices and/or memory size. The discovery process may be used in both a static or potentially dynamic system configurations. The kernel 10 may initialize the memory pool data structures for the kernel memory manager 40 based on the memory size and device information. The memory pools may be initialized in a default fashion (e.g. all permissions granted, least restrictive attributes) or the initial pools may also be provided via configuration file or other mechanism (block 84). The kernel 10 may also acquire Cids for the memory pools from the channel service 36 (block 86) and may start the kernel memory manager 40 and provide the Cids to the kernel memory manager 40 (block 88). The kernel 10 may start the kernel memory manager 40 after initializing the memory pool data structures and obtaining the Cids, or may start the kernel memory manager 40 and allow the kernel memory manager 40 to determine how to initialize the memory pool data structures and acquire the Cids from the channel service 36. The kernel memory manager 40 may create any desired memory pool slices (block 90) and may create channels to the memory pool slices (block 92). In addition to capturing the Cids for the memory pool slices, the kernel memory manager 40 may also create one or more channels on which the other threads in the system may communicate with the kernel memory manager 40. These Cids may be provided to various threads when they are initialized during boot.

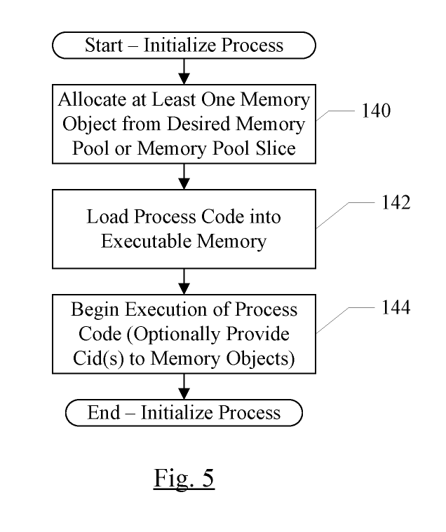

FIG. 5 is a flowchart illustrating operation of one embodiment of the kernel memory manager 40 when a process is being initialized, in an embodiment. While the blocks are shown in a particular order for ease of operation, other orders may be used. Blocks may be performed over multiple clock cycles. Various code sequences may include instructions which, when executed on a computing system, implement the operation shown in FIG. 5.

The kernel memory manager 40 may allocate at least one memory object for the process from a selected memory pool or memory pool slice (block 140). For example, the kernel memory manager 40 may allocate one or more memory objects that have execute permission in order to load the code corresponding to the process. The operating system may load the process's code into the allocated memory (block 142). Optionally, the kernel memory manager 40 may update the page tables 44 to map the virtual addresses for the code to the corresponding physical memory. The operating system may then begin execution of the process (optionally providing one or more Cids to the physical memory allocated to the process) (block 144).

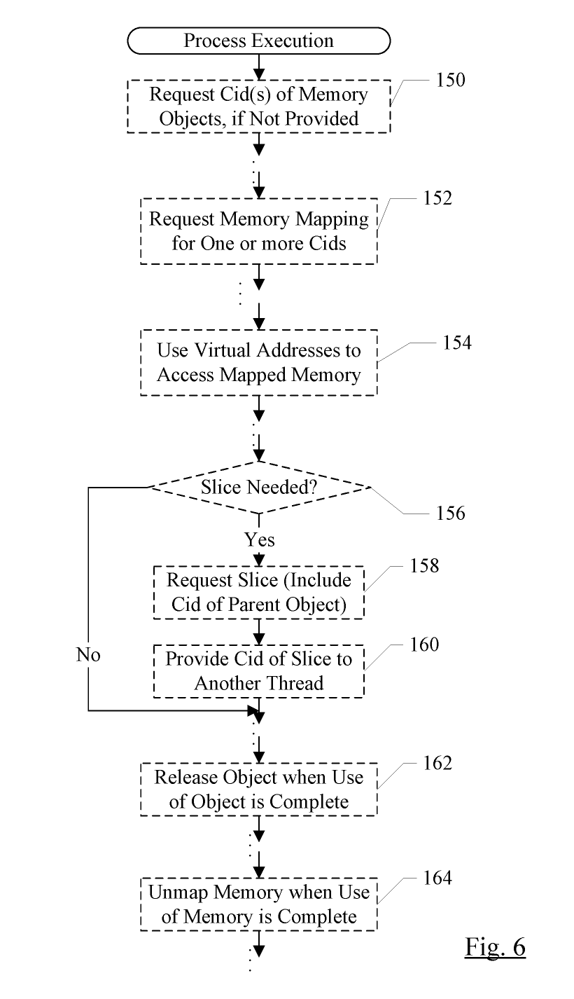

FIG. 6 is a flowchart illustrating various memory-related operations that may occur within a process, in an embodiment. The operations shown in FIG. 6 may be performed in different orders, and generally may be included or not included in a given process as desired. Thus, each operation is optional, illustrated by dashed boxes in the flowchart. The operations may be performed multiple times, in various embodiments. While the blocks are shown in a particular order for ease of operation, other orders may be used. Blocks may be performed over multiple clock cycles. Various code sequences may include instructions which, when executed on a computing system, implement the operation shown in FIG. 6.

If the Cid(s) for memory objects employed by the process are not provided to the process when it is started, the process may requests its Cids from the kernel memory manager 40 (block 150). In an embodiment, the process may be provided with a Cid to its executable memory (i.e. the pages in which the process is currently executing) and may request one or more other Cids (e.g. for data access). In other embodiments, all Cids may be provided when the process is started and Cid requests may not be needed.

The process may request mapping of one or more virtual address ranges to the physical memory ranges specified by the memory object(s) indicated by the Cid(s) (block 152). The process may transmit the virtual addresses with the request, for example. The process may use the virtual addresses to access the memory (block 154).

In some embodiments, the process may determine that a slice of one or more of the objects is needed (e.g. to restrict access of another thread or process to which the process is going to provide the slice) (decision block 156). If so (decision block 156, “yes” leg), the process may request a slice, transmitting the Cid of the parent object in the request (block 158). The process may provide the Cid of the slice to another thread, for example (block 160).

The process may determine that its use of a memory object is complete, and may release the memory object (block 162). For example, use may be complete if a portion of the process' task is complete and access to the memory object is no longer needed in view of the completion. Alternatively or in addition, a process may release its memory objects just before exiting. The release may be a request to the kernel memory manager 40, supplying Cids of memory objects to be released. Additionally, virtual memory address ranges may be unmapped if access to those virtual memory addresses is no longer needed (block 164).

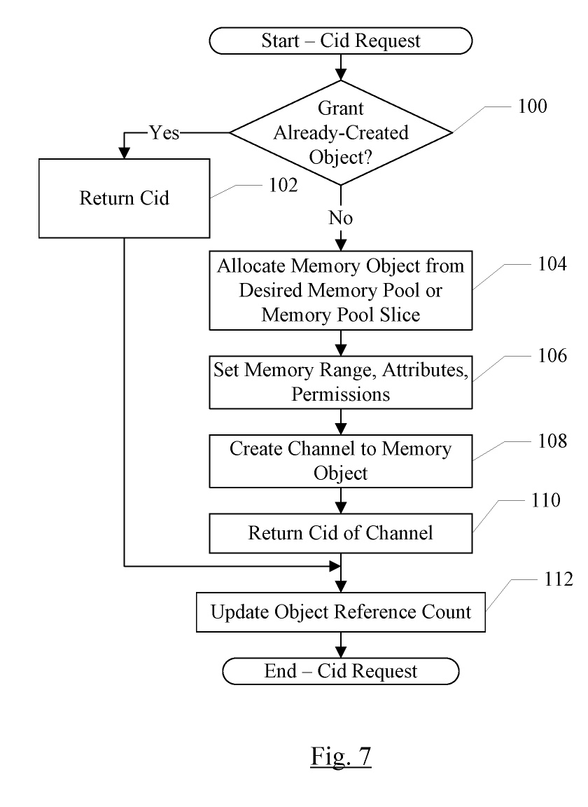

FIG. 7 is a flowchart illustrating operation of one embodiment of the kernel memory manager 40 in response to receiving a Cid request from a thread or process. The Cid request may specify the amount of memory needed, the type (normal or device), and the requested permissions/attributes for the memory. While the blocks are shown in a particular order for ease of operation, other orders may be used. Blocks may be performed over multiple clock cycles. Various code sequences may include instructions which, when executed on a computing system, implement the operation shown in FIG. 7.

The kernel memory manager 40 may determine if it wishes to grant an already-created memory object to the requestor (decision block 100). For example, the memory object may have been reserved for the process that contains the thread when the process was started. Alternatively, the kernel memory manager 40 may have one or more standard memory objects that it has prepared for satisfying Cid requests. If the kernel memory manager 40 determines to pass an already-created memory object to the requestor (decision block 100, “yes” leg), the kernel memory manager 40 may return the Cid of the memory object to the requestor (block 102).

On the other hand, if the kernel memory manager 40 does not wish to grant an already-created memory object to the requestor (decision block 100, “no” leg), the kernel memory manager 40 may select a memory pool or memory pool slice having appropriate permissions and attributes to fulfill the request (e.g. having the same attributes and permissions as those requested or less restrictive attributes/permissions than those requested) and may allocate a memory object from the memory pool/slice (block 104). The kernel memory manager 40 may set the memory range, attributes (from the parent pool/slice), and permissions (possibly more restrictive than the parent pool/slice, if needed to fulfill the memory request) (block 106). The kernel memory manager 40 may be responsible for recording which portions of the memory pools/slices have been allocated (or the kernel memory manager 40 may maintain the links between parents and children shown in FIG. 2 so that which portions have been allocated may be re-determined). The kernel memory manager 40 may communicate with the channel service 36 to allocate a channel to the allocated memory object (block 108), and may return the Cid of the channel to the memory requestor (block 110). Additionally, the kernel memory manager 40 may track references to each object, to ascertain whether or not there are any outstanding references to an object (e.g. when the object is returned to the kernel memory manager 40 or other references are deleted, as discussed in more detail below). In one embodiment, the kernel memory manager 40 may maintain a reference count, and may update the count (e.g. increment the count) for the object corresponding to the Cid that is returned to the requester (block 112).

It is noted that, in addition to the above operation, there may be responses refusing allocation to a thread/process. For example, there may not be any unallocated memory having the desired attributes/permissions (or less restricting attributes/permissions), or there may not be any unallocated memory at all. Additionally, in an embodiment, the kernel memory manager 40 may authenticate the requesting thread for the right to have the requested access to the requested memory. The authentication may particularly apply to device memory. If the authentication fails, the kernel memory manager 40 may respond with a refusal to allocate.

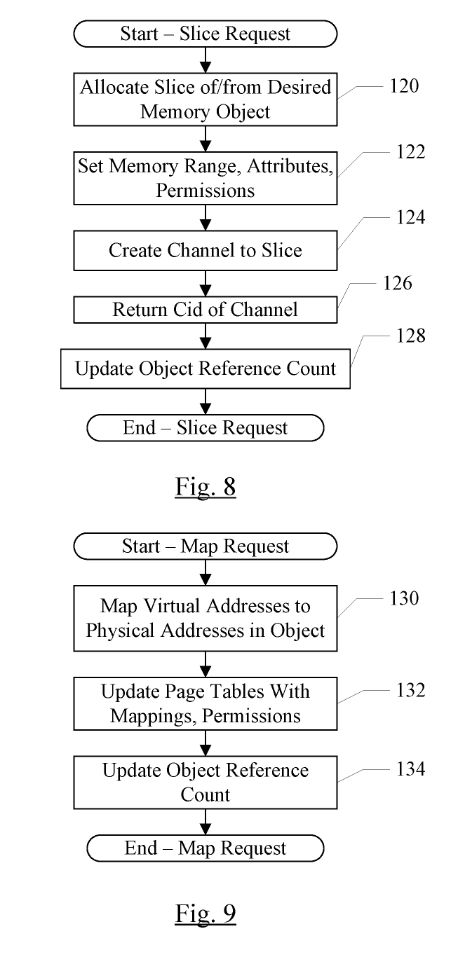

FIG. 8 is a flowchart illustrating operation of one embodiment of the kernel memory manager 40 in response to a request for a memory object slice from a thread/process. While the blocks are shown in a particular order for ease of operation, other orders may be used. Blocks may be performed over multiple clock cycles. Various code sequences may include instructions which, when executed on a computing system, implement the operation shown in FIG. 8.

The kernel memory manager 40 may allocate the object slice from the desired memory object (block 120) and may set the memory range, attributes, and permissions in the slice (block 122). The memory range may be specified in the slice request, and the permissions may be specified as well (although only the removal of a permission that is granted in the parent object is permitted; a permission that is not granted in the parent object may not be enabled). The attributes may be the same as the parent object. The kernel memory manager 40 may communicate with the channel service 36 to allocate a channel to the slice (block 124) and may return the Cid for the channel to the requestor (block 126). Additionally, the slice may be a reference to the parent object, and the Cid is a reference to the slice. Accordingly, the kernel memory manager 40 may update the reference count for the parent object and the reference count for the slice (e.g. the reference count for the slice may be initialized to one).

Turning now to FIG. 9, a flowchart is shown illustrating operation of one embodiment of the kernel memory manager 40 in response to a map request from a thread/process. While the blocks are shown in a particular order for ease of operation, other orders may be used. Blocks may be performed over multiple clock cycles. Various code sequences may include instructions which, when executed on a computing system, implement the operation shown in FIG. 9.

The requesting thread/process may indicate the virtual address range(s) to be mapped in the map request, or the kernel memory manager 40 may determine the range(s) from metadata corresponding to the thread/process (e.g. data read from a file that contains the thread/process code in a filesystem on the computing system). The kernel memory manager 40 may map the virtual address ranges to physical address ranges in the specified memory object (e.g. the map request may include the Cid to the memory object) (block 130). The kernel memory manager 40 may update the page tables 44 with translation data reflecting the mappings (block 132). The page tables may include permissions, and the kernel memory manager 40 may set the permissions based on the memory object's permissions (or more restrictive than the memory object's permissions, if requested). If the page tables include attributes (e.g. cacheability), the attributes may be set based on the memory object's attributes. Additionally, as long as the mappings are valid in the page tables 44, there is an implicit reference to the memory object. The kernel memory manager 40 may update the reference count for the memory object accordingly (e.g. incrementing the reference count) (block 134).

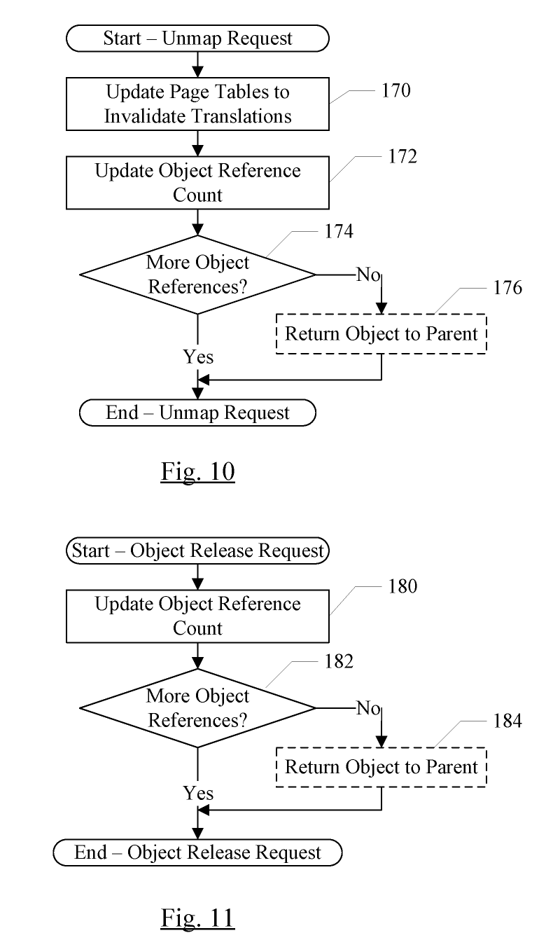

FIG. 10 is a flowchart illustrating operation of one embodiment of the kernel memory manager 40 in response to an unmap request from a thread/process. While the blocks are shown in a particular order for ease of operation, other orders may be used. Blocks may be performed over multiple clock cycles. Various code sequences may include instructions which, when executed on a computing system, implement the operation shown in FIG. 10.

A thread/process may transmit an unmap request to release page table mappings corresponding to a memory object. Accordingly, the kernel memory manager 40 may update the page tables to invalidate translations that map virtual addresses to the memory object (block 170). If translation data can be cached in the system (e.g. in translation lookaside buffers (TLBs) or a data in data caches), the kernel memory manager 40 may also make sure that the cached data is invalidated. Assuming that all translations to the memory object have been invalidated, the kernel memory manager 40 may update the object reference count (e.g. decrement the count) to reflect that the implicit reference to the object through the translation tables is no longer applicable (block 172). If there are no more references to the memory object (e.g. the object reference count is zero) (decision block 174, “no” leg), the kernel memory manager 40 may optionally return the memory object to its parent (block 176), thereby destroying the object.

FIG. 11 is a flowchart illustrating operation of one embodiment of the kernel memory manager 40 in response to an object request from a thread/process. While the blocks are shown in a particular order for ease of operation, other orders may be used. Blocks may be performed over multiple clock cycles. Various code sequences may include instructions which, when executed on a computing system, implement the operation shown in FIG. 11.

A thread/process may transmit an object release request to release a memory object that the thread/process is no longer using. The kernel memory manager 40 may update the object reference count (e.g. decrement the count) to reflect that the reference to the object via the Cid held by the thread is now gone (block 180). If there are no more references to the memory object (e.g. the object reference count is zero) (decision block 182, “no” leg), the kernel memory manager 40 may optionally return the memory object to its parent (block 184), thereby destroying the object.

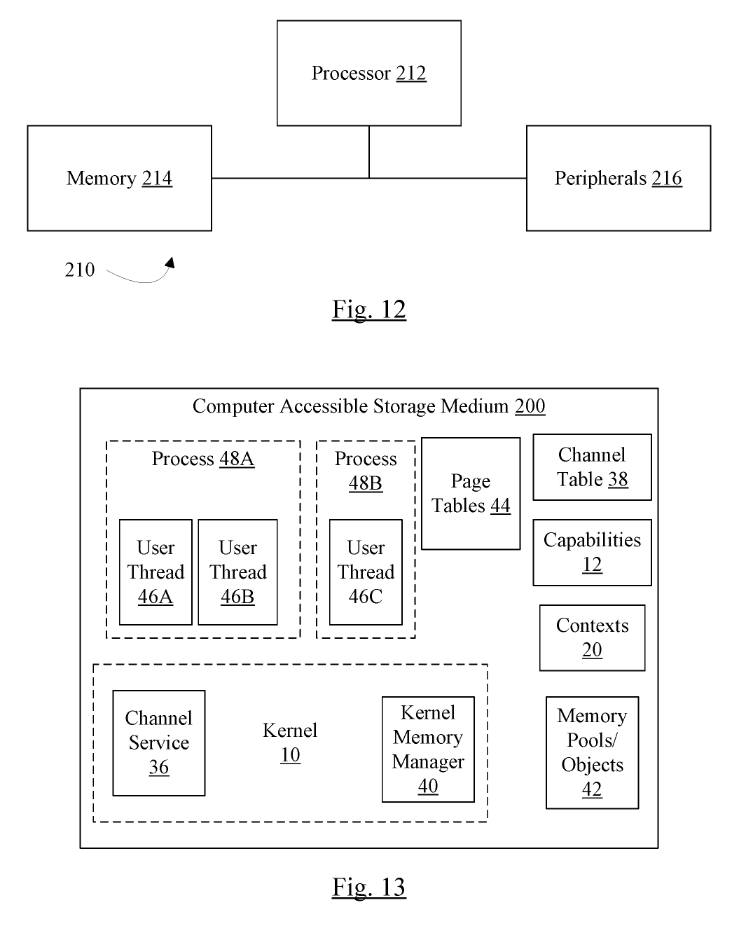

Turning now to FIG. 12, a block diagram of one embodiment of an exemplary computer system 210 is shown. In the embodiment of FIG. 12, the computer system 210 includes at least one processor 212, a memory 214, and various peripheral devices 216. The processor 212 is coupled to the memory 214 and the peripheral devices 216.

The processor 212 is configured to execute instructions, including the instructions in the software described herein such as the various capabilities functions, memory managers, kernel, user threads, etc. In various embodiments, the processor 212 may implement any desired instruction set (e.g. Intel Architecture-32 (IA-32, also known as x86), IA-32 with 64 bit extensions, x86-64, PowerPC, Sparc, MIPS, ARM, IA-64, etc.). In some embodiments, the computer system 210 may include more than one processor. The processor 212 may be the CPU (or CPUs, if more than one processor is included) in the system 210. The processor 212 may be a multi-core processor, in some embodiments.

The processor 212 may be coupled to the memory 214 and the peripheral devices 216 in any desired fashion. For example, in some embodiments, the processor 212 may be coupled to the memory 214 and/or the peripheral devices 216 via various interconnect. Alternatively or in addition, one or more bridges may be used to couple the processor 212, the memory 214, and the peripheral devices 216.

The memory 214 may comprise any type of memory system. For example, the memory 214 may comprise DRAM, and more particularly double data rate (DDR) SDRAM, RDRAM, etc. A memory controller may be included to interface to the memory 214, and/or the processor 212 may include a memory controller. The memory 214 may store the instructions to be executed by the processor 212 during use, data to be operated upon by the processor 212 during use, etc. The memory 214 may be at least a portion of the memory that is described by the normal memory pools in the memory pool/objects 42.

Peripheral devices 216 may represent any sort of hardware devices that may be included in the computer system 210 or coupled thereto (e.g. storage devices, optionally including a computer accessible storage medium 200 such as the one shown in FIG. 15), other input/output (I/O) devices such as video hardware, audio hardware, user interface devices, networking hardware, various sensors, etc.). Peripheral devices 216 may further include various peripheral interfaces and/or bridges to various peripheral interfaces such as peripheral component interconnect (PCI), PCI Express (PCIe), universal serial bus (USB), etc. The interfaces may be industry-standard interfaces and/or proprietary interfaces. The various peripheral devices 216 may be memory mapped and represented in the device memory pools in the memory pool/objects 42. In some embodiments, the processor 212, the memory controller for the memory 214, and one or more of the peripheral devices and/or interfaces may be integrated into an integrated circuit (e.g. a system on a chip (SOC)).

The computer system 210 may be any sort of computer system, including general purpose computer systems such as desktops, laptops, servers, etc. The computer system 210 may be a portable system such as a smart phone, personal digital assistant, tablet, etc. The computer system 210 may also be an embedded system for another product.

FIG. 13 is a block diagram of one embodiment of a computer accessible storage medium 200. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 200 may store data in a non-transitory manner, where non-transitory in this context may refer to not transmitting the instructions/data on a signal. For example, non-transitory storage may be volatile (and may lose the stored instructions/data in response to a power down) or non-volatile.

The computer accessible storage medium 200 in FIG. 12 may store code forming the kernel 10, including the kernel memory manager 40 and the channel service 36, the user threads 46A-46C in the user processes 48A-48B, and/or the functions in the capabilities 12. The computer accessible storage medium 200 may still further store one or more data structures such as the channel table 38, the memory pools/objects 42, the page tables 44, and/or the contexts 20. The kernel memory manager 40 and the channel service 36, the user threads 46A-46C, the processes 48A-48B, and/or the functions in the capabilities 12 may comprise instructions which, when executed, implement the operation described above for these components. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

1. A non-transitory computer accessible storage medium storing a plurality of instructions that are computer-executable to:
establish a plurality of memory pools, wherein each memory pool of the plurality of memory pools describes one or more memory address ranges and identifies at least one attribute and at least one permission for the one or more memory address ranges;
obtain a plurality of channels to communicate with the plurality of memory pools, wherein each of the plurality of channels provides communication with a respective memory pool of the plurality of memory pools; and
provide a plurality of channel identifiers corresponding to the plurality of channels to a kernel memory manager that executes in privileged mode in a system.

2. The non-transitory computer accessible storage medium as recited in claim 1 wherein the at least one attribute includes an indication that the one or more address ranges are random access memory.

3. The non-transitory computer accessible storage medium as recited in claim 2 wherein the at least one attribute includes a cacheability associated with the one or more address ranges.

4. The non-transitory computer accessible storage medium as recited in claim 1 wherein the at least one attribute includes an indication that the one or more address ranges are device memory.

5. The non-transitory computer accessible storage medium as recited in claim 4 wherein the at least one attribute includes an ordering property associated with one or more devices addressed by the one or more address ranges.

6. The non-transitory computer accessible storage medium as recited in claim 1 wherein the permissions include at least a read permission, a write permission, and an execute permission.

7. A non-transitory computer accessible storage medium storing a plurality of instructions that are computer-executable as a first memory manager to:
receive a first request for memory from a first thread, the request including an indication of one or more requested attributes and one or more requested permissions to the memory for the first thread;
select a first memory pool of a plurality of memory pools having one or more attributes and one or more permissions that allow for the one or more requested attributes and the one or more requested permissions, wherein each memory pool of the plurality of memory pools describes one or more memory address ranges, and wherein the first memory manager communicates with the plurality of memory pools via a plurality of channels;
create a first memory object from the first memory pool;
obtain a first channel from a channel service;
associate a first channel identifier of the first channel with the first memory object; and
return the first channel identifier to the first thread.

8. The non-transitory computer accessible storage medium as recited in claim 7 wherein the first memory manager is executable to:
establish a plurality of memory pool slices derived from a first memory pool of the plurality of memory pools, where each of the plurality of memory pool slices describes a subset of the one or more memory addresses and includes at least one second attribute allowed by the at least one attribute of the first memory pool and one or more second permissions allowed by the one or more permissions of the first memory pool;
obtain a second plurality of channels to communicate with the plurality of memory pool slices.

9. The non-transitory computer accessible storage medium as recited in claim 8 wherein the first memory manager is executable to:
receive a second request for memory from a second thread, the request including an indication of one or more second requested attributes and one or more second requested permissions to the memory for the second thread;
select a first memory pool slice of the plurality of memory pool slices having one or more second attributes and one or more second permissions that allow for the one or more second requested attributes and the one or more second requested permissions;
create a second memory object from the first memory pool slice;
obtain a second channel from a channel service;
associate a second channel identifier of the second channel with the second memory object; and
return the second channel identifier to the second thread.

10. The non-transitory computer accessible storage medium as recited in claim 7 wherein a first attribute of the one or more attributes of the first memory pool allows for a second attribute of the one or more requested attributes if the second attribute is more restrictive than the first attribute.

11. The non-transitory computer accessible storage medium as recited in claim 7 wherein a first attribute of the one or more attributes of the first memory pool allows for a second attribute of the one or more requested attributes if the second attribute is the same as the first attribute.

12. The non-transitory computer accessible storage medium as recited in claim 7 wherein a first permission of the first memory pool allows for a second permission if the second permission is more restrictive than the first permission.

13. The non-transitory computer accessible storage medium as recited in claim 12 wherein the first permission is more restrictive than the second permission if at least one permission in the second permission is not permitted in the first permission.

14. The non-transitory computer accessible storage medium as recited in claim 7 wherein a first permission of the one or more access permissions of the first memory pool allows for a second permission of the one or more requested access permissions if the second permission is the same as the first permission.

15. The non-transitory computer accessible storage medium as recited in claim 7 wherein the first thread is executable to:
receive a second request for memory from a second thread, the request including an indication of one or more second requested attributes and one or more second requested permissions to the memory for the second thread, wherein the one or more requested attributes for the first memory object allow for the one or more second requested attributes and the one or more requested permissions allow for the one or more second requested permissions;
create a first memory object slice from the first memory object, wherein the first memory object slice describes a first memory address range that is a subset of a second memory address range of the first memory object;
obtain a second channel from the channel service;
associate a second channel identifier of the second channel with the first memory object slice; and
return the second channel identifier to the second thread.

16. A system comprising:
one or more processors; and
a non-transitory computer accessible storage medium coupled to the one or more processors and storing a plurality of instructions that are executable on the one or more processors as a first memory manager to:
receive a first request for memory from a first thread, the request including an indication of one or more requested attributes and one or more requested permissions to the memory for the first thread;
select a first memory pool of a plurality of memory pools having one or more attributes and one or more permissions that allow for the one or more requested attributes and the one or more requested permissions, wherein each memory pool of the plurality of memory pools describes one or more memory address ranges, and wherein the first memory manager communicates with the plurality of memory pools via a plurality of channels;
create a first memory object from the first memory pool;
obtain a first channel from a channel service;
associate a first channel identifier of the first channel with the first memory object; and
return the first channel identifier to the first thread.

17. The system as recited in claim 16 wherein the non-transitory computer accessible storage medium stores a second plurality of instructions which are executable on the one or more processors to:
establish the plurality of memory pools;
obtain a plurality of channels to communicate with the plurality of memory pools, wherein each of the plurality of channels provides communication with a respective memory pool of the plurality of memory pools; and
provide a plurality of channel identifiers corresponding to the plurality of channels to the first memory manager.

18. The system as recited in claim 16 wherein the first memory manager is executable to:
establish a plurality of memory pool slices derived from a first memory pool of the plurality of memory pools, where each of the plurality of memory pool slices describes a subset of the one or more memory addresses and includes at least one second attribute allowed by the at least one attribute of the first memory pool and one or more second permissions allowed by the one or more permissions of the first memory pool;
obtain a second plurality of channels to communicate with the plurality of memory pool slices.

19. The system as recited in claim 18 wherein the first memory manager is executable to:
receive a second request for memory from a second thread, the request including an indication of one or more second requested attributes and one or more second requested permissions to the memory for the second thread;
select a first memory pool slice of the plurality of memory pool slices having one or more second attributes and one or more second permissions that allow for the one or more second requested attributes and the one or more second requested permissions;
create a second memory object from the first memory pool slice;
obtain a second channel from a channel service;
associate a second channel identifier of the second channel with the second memory object; and
return the second channel identifier to the second thread.

20. The system as recited in claim 16 wherein a first attribute of the one or more attributes of the first memory pool allows for a second attribute of the one or more requested attributes if the second attribute is more restrictive than the first attribute or the same as the first attribute, and wherein a first permission of the first memory pool allows for a second permission if the second permission is more restrictive than the first permission or the same as the first permission.
